(19) United States
(12) Patent Application Publication
(10) Pub. No.: US 2026/0235026 A1
(43) Pub. Date: Aug. 13, 2026

(54) RADIO FREQUENCY IDENTIFIER BASED TELEMETRY FOR SURFACE AND DOWNHOLE COMMUNICATION

(71) Applicant: Schlumberger Technology Corporation, Sugar Land, TX (US)

(72) Inventor: Elias Temer, Clamart (FR)

(21) Appl. No.: 19/078,622

(22) Filed: Mar. 13, 2025

(30) Foreign Application Priority Data
Feb. 7, 2025 (EP) 25305177.5

(51) Int. Cl. E21B 47/12; E21B 34/10; E21B 47/09; E21B 49/00; G06K 19/04; G06K 19/07

(52) U.S. Cl. CPC E21B 47/138; E21B 47/09; G06K 19/041; G06K 19/0723; E21B 21/103; E21B 2200/05

(57) ABSTRACT

Certain aspects of the present disclosure provide a radio frequency identifier (RFID) telemetry system. The RFID telemetry system includes a first radio frequency identified (RFID) antenna at a surface of a wellbore; a second RFID antenna downhole in the wellbore; and a plurality of RFID devices. The plurality of RFID devices are configured to travel inside a pipe within the wellbore to the second RFID antenna while drilling fluid is being circulated inside the wellbore; receive downhole data from the second RFID antenna; travel inside an annulus outside the pipe in the wellbore to the first RFID antenna; and provide the downhole data to the first RFID antenna.

### BACKGROUND

### Field of the Disclosure

Aspects of the present disclosure relate to hydrocarbon production and, more particularly, to techniques for communication between downhole and surface equipment.

### Description of Related Art

Oil and gas drilling is a complex process that involves several stages to construct wells in order to reach subsurface reservoirs and extract hydrocarbons from beneath the Earth's surface. The drilling process typically begins with setting up a drilling rig at a designated site, where the crew prepares to drill a well.

An initial step in drilling a well may involve drilling a surface hole down to a predetermined depth using a drill bit attached to a drill string to overcome resistance of the rock, crushing it into small pieces (i.e., cuttings). During drilling, drill mud may be circulated, which serves multiple purposes, including cooling and lubricating the drill bit and carrying rock cuttings to the surface. Once the desired depth is reached, steel casing pipes are inserted into the wellbore and cemented in place. This casing provides structural support to prevent the well from collapsing and isolates different geological layers within the well to prevent fluids contained in the drilled formation from entering the well. The drilling continues until it reaches the target depth where oil or gas deposits are expected.

During and after drilling, various tests may be conducted to evaluate the well, including logging tools that measure rock properties and fluid sampling. After evaluation, if the well is deemed productive, the well undergoes completion processes to facilitate oil or gas extraction.

Well logging in the oil and gas industry is the process of recording detailed information about the geological formations penetrated by a borehole. This information is crucial for evaluating the potential for oil and gas production and for understanding the subsurface conditions. Well logging can be performed during or after drilling, and it provides data that help geologists, engineers, and operators make informed decisions about exploration, drilling, and production.

Well logging instruments may include one or more transmitters, sensors, actuators, and other devices that measure various properties of the subsurface rock formations and/or perform certain physical or mechanical acts on the formations, such as drilling or percussively obtaining samples of the rock formations and withdrawing samples of connate fluid from the rock formations.

One example of well logging is mud logging which involves analyzing drilling fluid (mud) and cuttings brought to the surface to identify the composition and properties of the formation. Another example of well logging is wireline logging in which instruments are lowered into the borehole on a cable (i.e., a wireline) to collect data. Another example of well logging is logging while drilling (LWD) in which sensors are integrated into the drill string to collect data in real-time during the drilling process. LWD may be used for expensive drilling operations, where the time needed to suspend drilling operations in order to make the wellbore accessible to wireline instruments would make the cost of such access prohibitive, and for wellbores having a substantial lateral displacement from the surface location of the well. LWD instrumentation is typically used in conjunction with measurement while drilling (MWD) instrumentation. MWD instruments may include navigation sensors that determine the trajectory of the wellbore and sensors that measure mechanical parameters such as torque applied to the pipe string, vibration, angular acceleration, and pressure in the annular space between the wall of the wellbore and the drill string.

Logging measurements may include resistivity logging that measures the resistance of the formation to electrical current, which helps determine fluid content (e.g., oil, gas, or water). Logging measurements may include gamma ray logging to detect natural radioactivity in the formation, which helps to distinguish between shale and sand layers. Logging measurements may include density and porosity logging that measures the density and porosity of the formation, which helps estimate the amount of recoverable hydrocarbons. Logging measurements may include sonic or acoustic logging, which uses sound waves to determine formation properties like porosity, rock strength, and fluid type. Logging measurements may include nuclear magnetic resonance (NMR) logging that measures properties of hydrogen nuclei to assess porosity and fluid types. Logging measurements may include caliper logging that measures the diameter of the borehole, which helps detect washouts or borehole stability issues.

Measurements of the properties of the rock formations made by the sensors may be indexed with respect to the time at which the measurements are made and recorded with respect to the instrument axial position (i.e., depth) within the wellbore as the instrument is moved along the wellbore. Such recording is referred to as a well log. Well logging data is essential for maximizing the productivity and safety of oil and gas operations. Well logging data may be used to determine the potential hydrocarbon-bearing zones and estimate reserves. Well logging data may be used to understand the rock and fluid properties of the formation. Well logging data may be used to optimize drilling, for example, to identify zones that may cause drilling problems, such as fractures or unstable formations. Well logging data may be used for production planning, such as to design efficient extraction techniques based on formation properties.

Real time downhole data while drilling is critical to ensure safe operations, to collect borehole data, to optimize the trajectory of the well through geosteering, and to optimize the drilling costs. To ensure real time data acquisition, a reliable telemetry system is needed.

Signals from the various downhole sensors, and signals from the surface (e.g., control and/or command signals) to the downhole sensors, may be communicated to the Earth's surface (e.g., to a data acquisition and recording unit disposed at the Earth's surface) via a telemetry unit. Existing telemetry approaches may include wired drill pipe telemetry devices, electromagnetic (or optical) signal telemetry devices, and/or fluid flow modulation telemetry devices. However, these telemetry approaches have limitations and drawbacks.

Wired pipes telemetry can ensure high data throughput for real-time data, however, it can be very expensive to deploy.

Electromagnetic telemetry works by injecting current into the formation rather than modulating mud pulses. The electromagnetic signal can travel through the casing and the formation to the surface. Electromagnetic telemetry reduces the survey time by transmitting data during pumps off. Electromagnetic telemetry is reliable as there are no moving parts in the system. However, there are some cases where electromagnetic telemetry does not work properly, for example, in some offshore environments.

An example of a fluid modulation telemetry device is a mud pulse telemetry device that modulates the flow of drilling fluid as the fluid is pumped through the drill string. One or more pressure transducers disposed at the surface detect pressure changes caused by the modulator. The detected pressure changes are then decoded into the signals that were transmitted by the logging instruments. Mud flow modulation telemetry is slow, for example typically limited to a transmission rate of a few bits per second. Further, mud pulse telemetry can only be used during specific phases of the drilling operations.

Even when using multiple data communication systems (e.g., both wired drill pipe and mud flow modulation), the volume of data generated by the logging instruments can be large relative to the transmission rate of the telemetry devices. For example, increasing water depth, total well depth, synthetic mud systems and measurement complexity increases the needed transmission rate for real-time data transmission. Further, in deepwater environments, where the use of synthetic oil-based mud is prevalent, low water temperature significantly increases mud viscosity which reduces the signal strength at surface and makes detection of the signal more difficult. Noise within the mud channel further hinders the transmission of data.

Accordingly, what is needed is a new telemetry technique and apparatus for surface and downhole communication to increase data throughput and reliability of the acquisition system.

### SUMMARY

One aspect provides a system for radio frequency identifier (RIFD) telemetry. The system includes a first RFID antenna at a surface of a wellbore; a second RFID antenna downhole in the wellbore; and a plurality of RFID devices. The plurality of RFID devices are configured to, while drilling fluid is being circulated inside the wellbore, flow downhole from a surface of the wellbore to the second RFID antenna, wherein the plurality of RFID devices are configured to flow within a pipe carrying the drilling fluid inside the wellbore. The plurality of RFID devices are configured to, while drilling fluid is being circulated inside the wellbore, flow uphole back to the first RFID antenna at the surface, wherein the plurality of RFID devices are configured to flow within an annulus outside the pipe in the wellbore. The second RFID antenna is configured to transmit downhole data to the plurality RFID devices when the plurality of RFID devices reaches the second RFID antenna downhole. The first RFID antenna is configured to read the downhole data when the plurality of RFID devices reaches the first RFID antenna at the surface.

Another aspect provides a method for communication between surface and downhole components at a wellbore. The method includes introducing a plurality of (RFID devices to a drilling fluid at a surface of the wellbore. The method includes pumping the drilling fluid and the plurality of RFID devices through a pipe within the wellbore, into an annulus outside the pipe within the wellbore, and back to the surface. The method includes broadcasting data to the plurality of RFID devices, using a downhole RFID antenna. The method includes reading the data using a surface RFID antenna at the surface.

Another aspect provides a method for communication between surface and downhole components at a wellbore. The method includes receiving, at one or more downhole processors, raw downhole data from a plurality of downhole well logging instruments. The method includes at least one of: time stamping, compressing, encrypting, or buffering the raw data. The method includes detecting a presence of one or more radio frequency identified (RFID) devices flowing in a pipe within the wellbore. The method includes broadcasting, using a downhole RFID antenna, the downhole data to the one or more RFID devices in response to the detection.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting the scope of this disclosure.

FIG. 1 depicts an example drilling system according to certain aspects.

FIG. 2 illustrates an example drilling system with RFID telemetry according to certain aspects.

FIG. 3 illustrates an example of RFID devices flowing downhole in a drill string and back to the surface through an annulus in the drilling system of FIG. 2 according to certain aspects.

FIG. 4 illustrates an example of operations by a downhole RFID telemetry hub according to certain aspects.

FIG. 5 illustrates an example mechanism to prevent the RFID devices from flowing to the drill bit according to certain aspects.

FIG. 6 illustrates a segregator to collect the RFID devices at the surface according to certain aspects.

FIG. 7 illustrates reading of the RFID devices at the surface and processing of the telemetry data.

FIG. 8 illustrates an example method for RFID telemetry according to certain aspects.

### DETAILED DESCRIPTION

Aspects of the present disclosure provide apparatuses, methods, systems, and computer-readable mediums for RFID telemetry for communications between surface and downhole equipment at a wellbore. In some aspects, the RFID telemetry may be used for communicating well logging information measured downhole to surface equipment and/or for controlling well logging instruments from the surface.

In some aspects, the RFID telemetry may be used in addition to other communication device, such as in additional mud pulse telemetry. In some aspects, the RFID telemetry may be used for communication between downhole devices. In some aspects, the RFID telemetry may be used for communication of other types of data (e.g., other than control and well logging data).

### Example Drilling System

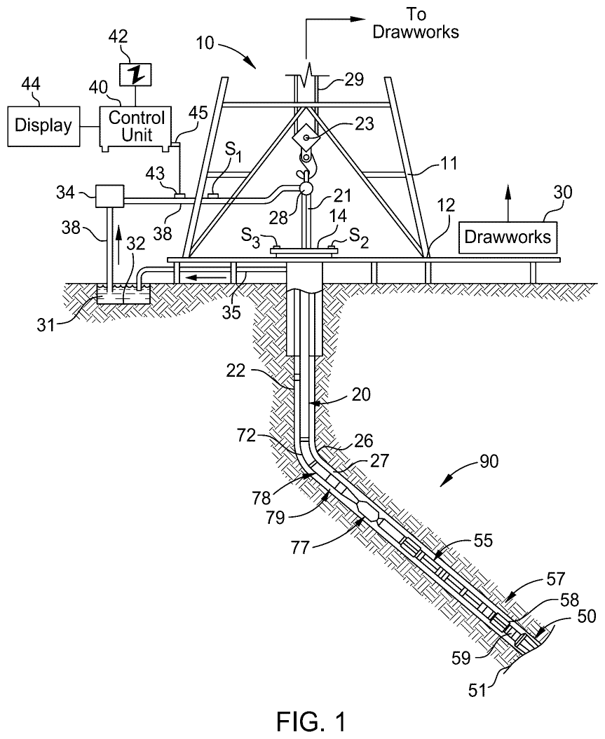

FIG. 1 depicts an example drilling system 10 in which well logging and RFID telemetry may be performed according to certain aspects. It should be understood that FIG. 1 merely depicts an example drilling system, and that the RFID telemetry techniques described herein may be performed in any drilling system.

FIG. 1 shows a schematic diagram of a drilling system 10 with a drill string 20 carrying a drilling assembly 90, also referred to as the bottomhole assembly (BHA), conveyed in a “wellbore” or “borehole” 26 for drilling the borehole. A drilling rig suspends a conduit called the drill string 20 within a wellbore 26 being drilled through subsurface formations. The drill string 20 may be assembled by threadedly coupling together end to end a number of segments (“joints”) of drill pipe. The end of the drill string 20 includes a drill bit 50 at its lower end.

The drilling system 10 depicts a conventional derrick 11 erected on a floor 12 which supports a rotary table 14 that is rotated by a prime mover such as an electric motor (not shown) at a desired rotational speed. The drill string 20 includes tubing such as a drill pipe 22 or a coiled-tubing extending downward from the surface into the borehole 26. The drill string 20 is pushed into the borehole 26 when a drill pipe 22 is used as the tubing. For coiled-tubing applications, a tubing injector, such as an injector (not shown), however, is used to move the tubing from a source thereof, such as a reel (not shown), to the borehole 26. The drill bit 50 attached to the end of the drill string 20 breaks up the geological formations when it is rotated to drill the borehole 26. If a drill pipe 22 is used, the drill string 20 is coupled to a drawworks 30 via a kelly joint 21, swivel 28, and line 29 through a pulley 23. During drilling operations, the drawworks 30 is operated to control the weight on bit, which is an important parameter that affects the rate of penetration.

During drilling operations, a suitable drilling fluid 31 from a mud pit (source) 32 is circulated under pressure through a channel in the drill string 20 by a mud pump 34 (or slush pump). The drilling fluid passes from the mud pump 34 into the drill string 20 via a desurger (not shown), fluid line 38, and kelly joint 21.

The drilling fluid 31 is discharged at the borehole bottom 51 through an opening in the drill bit 50. The drilling fluid 31 circulates uphole through the annular space 27 between the drill string 20 and the borehole 26 and returns to the mud pit 32 via a return line 35. In some aspects, a shale shaker separates the cuttings from the drilling mud to allow the mud to be reused. The drilling fluid acts to lubricate the drill bit 50 and to carry borehole cutting or chips away from the drill bit 50. In some aspects, the system includes one or more mud tanks configured to hold the drilling fluid after its cleaned by the shale shaker.

In some aspects, measurement instruments (e.g., MWD and LWD instruments) may be disposed in thick-walled segments of pipe called drill collars, and such collars are disposed proximate the lower end of the drill string 20. A sensor Si placed in the line 38 can provide information about the fluid flow rate. A surface torque sensor S2 and a sensor S3 associated with the drill string 20, respectively, provide information about the torque and rotational speed of the drill string. Additionally, a sensor (not shown) associated with line 29 is used to provide the hook load of the drill string 20.

The drill bit 50 can be rotated by only rotating the drill pipe 22. Alternatively, a downhole motor 55 (mud motor) disposed in the drilling assembly 90 can rotate the drill bit 50 and the drill pipe 22 is rotated usually to supplement the rotational power and to effect changes in the drilling direction. The mud motor 55 may be coupled to the drill bit 50 via a drive shaft (not shown) disposed in a bearing assembly 57. The mud motor 55 rotates the drill bit 50 when the drilling fluid 31 passes through the mud motor 55 under pressure. The bearing assembly 57 supports the radial and axial forces of the drill bit 50. A stabilizer 58 coupled to the bearing assembly 57 acts as a centralizer for the lowermost portion of the mud motor 55 assembly.

A drilling sensor module 59 may be placed near the drill bit 50. The drilling sensor module 9 may contain sensors, circuitry, and processing software and algorithms relating to the dynamic drilling parameters. Such parameters can include bit bounce, stick-slip of the drilling assembly 90, backward rotation, torque, shocks, borehole and annulus pressure, acceleration measurements, and other measurements of the drill bit condition. A suitable telemetry or communication subsystem 77 using, for example, two-way telemetry, is also provided as illustrated in the drilling assembly 90. The drilling sensor module 59 processes the sensor information and transmits it to the surface control unit 40 via the telemetry system 77. In some aspects, the telemetry may be a mud pulse telemetry system. As discussed in more detail herein, RFID telemetry may be used in addition to, or alternatively to, the telemetry system 77.

The telemetry system 77, a power unit 78 and a well logging instrument 79 are all connected in tandem with the drill string 20. In some aspects, the well logging instrument 79 is a MWD drilling instrument, a LWD drilling instrument, or other well logging instrument. Flex subs may be used in connecting the well logging instrument 79 in the drilling assembly 90. Such subs and tools may form the bottom hole drilling assembly 90 between the drill string 20 and the drill bit 50.

The drilling assembly 90 may include several instruments. These instruments may be any tool or device capable of operation in a wellbore 26. For example, some instruments measure a characteristic of the drill string 50, the wellbore 26 or the formations. The drilling assembly 90 may make various measurements while the borehole 26 is being drilled. The telemetry system 77 obtains the signals and measurements and transfers the signals, using two-way telemetry, for example, to be processed on the surface. Alternatively, the signals can be communicated to and processed using a downhole processor at a suitable location (not shown) in the drilling assembly 90.

The surface control unit 40 or processor may also receive one or more signals from other downhole sensors and devices and signals from sensors S1-S3 and other sensors used in the system 10 and processes such signals according to programmed instructions provided to the surface control unit 40. The surface control unit 40 may display desired drilling parameters and other information on a display/monitor 44 utilized by an operator to control the drilling operations. The surface control unit 40 can include a computer or a microprocessor-based processing system, memory for storing programs or models and data, a recorder for recording data, and other peripherals. The control unit 40 can be adapted to activate alarms 42 when certain unsafe or undesirable operating conditions occur.

### Example Radio Frequency Identifier (RFID) Telemetry for Surface and Downhole Communication

According to certain aspect, a drilling system (e.g., such the drilling system 10 depicted in FIG. 1) includes a new method and communication system enabling data transmission during the drilling operations. In some aspects, the method and communication system are used for communication between surface and downhole devices of the drilling system. In some aspects, the method and communication system improve the bandwidth (transmission rate) of information in the drilling system.

The method and communication system uses RFID to communicate data. RFID is a technology that transmits data through radio waves. RFID allows identification and tracking of individual items, as well as multiple items simultaneously, without a direct line of sight.

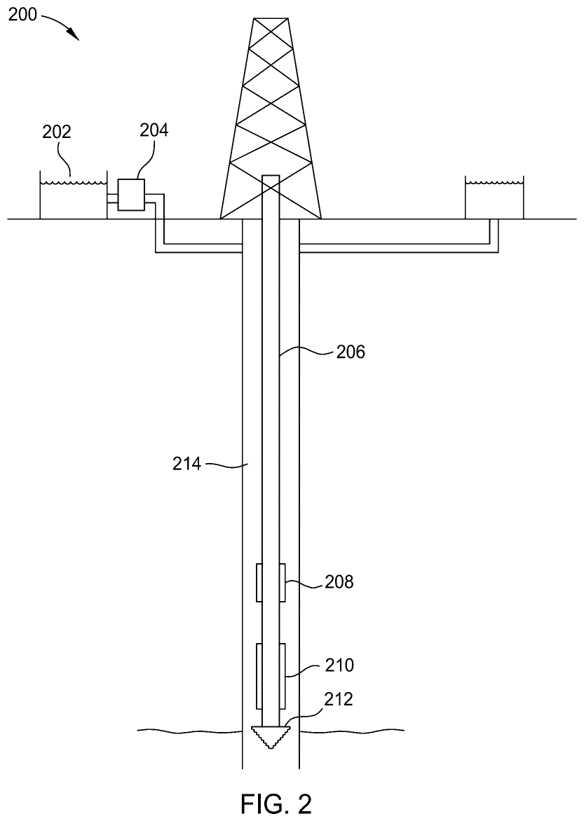

FIG. 2 illustrates an example drilling system 200 with RFID telemetry according to certain aspects. As shown in FIG. 2, the drilling system 200 may include a mud pit 202, shakers 204, drill string 206, RFID detector 208, RFID telemetry hub 210, drill bit 212, and annulus 214. It should be understood that while FIG. 2 illustrates certain comments of the drilling system, that the drilling system 200 may include additional components.

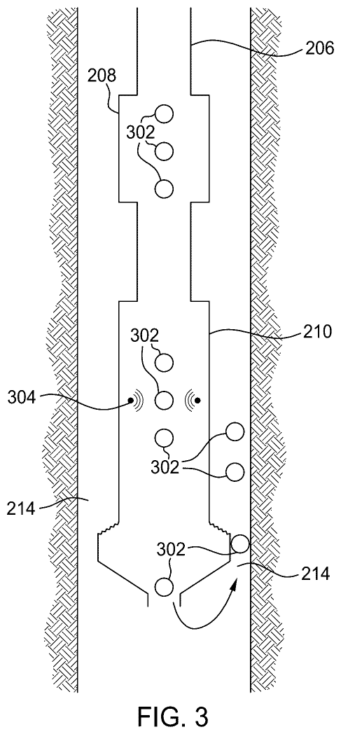

According to certain aspects, the example drilling system 200 uses multiple RFID devices that travel from the surface to downhole and back to the surface to communicate information between the surface and downhole instruments. FIG. 3 illustrates an example of RFID devices 302 flowing downhole in the drill string 206 and back to the surface through the annulus 214 according to certain aspects.

In some aspects, the RFID devices 302 communicate data between downhole well logging instruments (not shown) and surface data acquisition equipment (not shown). As shown in FIG. 3, the RFID devices 302 may travel inside the drill string 206 to the bottom hole assembly and return back to the surface through the annulus 214 formed between the drill string 206 and a casing or borehole wall.

In some aspects, the RFID devices 302 may be an RFID tag embedded in an object that can be pumped through the well bore (e.g., wellbore 26) during circulation of drilling fluid while drilling. The RFID tags can be written, rewritten, and reused. The RFID devices 302, and RFID antennas 304, can be extremely durable against impact and environmental factors, such as the extreme downhole conditions (e.g., high pressure and high temperature conditions). In some aspects, the RFID devices 302 and RFID antennas 304 may withstand temperatures up to 200 degrees Celsius.

In some aspects, multiple RFID devices 302 are used in order to overcome low signal to noise ratio (SNR). For example, multiple RFID devices 302 may be written with the same data in order to create redundancy, which improves the SNR. In some aspects, the total number of the RFID devices 302 being circulated in the well can be controlled. For example, increasing the number of RFID devices 302 can increase the throughput and/or reliability of the communication. However, too many RFID devices 302 in the well may jam the circulation of the mud in the well. In some aspects, the circulation of the RFID devices 302 may be spaced in time so that the RFID devices 302 are spatially distributed in the well.

In some aspects, a backward volume calculation can be performed. For example, based the properties of the drilling fluid, the rate of penetration, and the geometry of the wellbore, the volume of the RFID devices 302, the path (e.g., the depth as a function of time) of the RFID devices through the wellbore can be estimated. In some aspects, the estimated path may be used at the RFID telemetry hub 210 to determine when the RFID devices 302 will arrive and to begin broadcasting data. In some aspects, the estimated path may be used at the surface to determine when to circulate RFID devices 302 in the wellbore.

The data can be encrypted for extra security before the data is broadcast to the RFID devices 302. RFID tags can hold more data than other types of tags or labels. In some aspects, the RFID devices 302 include RFID tags embedded in balls. In some aspects, the material and size of the RFID may depend on the configuration of the drilling system, including the depth of the well, such that the RFID devices 302 will not get stuck and will not damage the surface or downhole equipment. In some aspects, the RFID tags are embedded in rubber balls. In some aspects, the RFID device may be on the order of 1 inch to 2 inches (e.g., approximately the size of a golf ball).

As shown in FIG. 3, the RFID devices 302 may travel downhole inside the drill string 206. In some aspects, the RFID devices 302 are circulated in the well bore while the drilling system 200 circulates mud in the well.

As shown in FIG. 3, the drilling system 200 may include an RFID detector 208 configured to detect presence of the RFID devices 302 and notify the RFID telemetry hub 210 of the detection of the RFID devices 302. For example, by using the RFID detector 208 to detect the presence of the RFID devices 302, energy can be saved at the telemetry hub 210, as the RFID antenna does not need to continue broadcast, but can begin broadcasting of the telemetry data in response to being notified of the detection of the RFID device 302. In some aspects, the data may include LWD data, MWD data, sensor data, borehole images, logs, events, and/or other downhole data.

As shown in FIG. 3, the RFID telemetry hub 210 broadcasts data to the RFID devices 302 as the RFID devices 302 pass the telemetry hub 210. For example, the RFID telemetry hub 210 includes one or more RFID antennas 304 configured to broadcast the data to the RFID devices 302. In some aspects, the RFID telemetry hub 210 may also be configured to read surface information from the RFID devices 302. For example, the surface information may include control or other communications written to the RFID devices 302 from the surface equipment. In some aspects, the RFID telemetry hub 210 includes an RFID. RFID readers can read multiple (e.g., hundreds) tags within seconds.

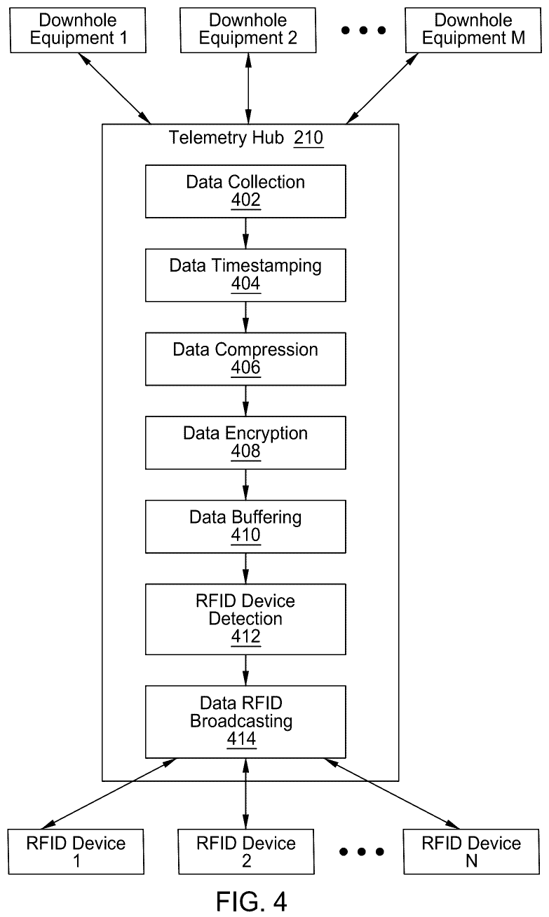

FIG. 4 illustrates example operation of the downhole RFID telemetry hub 210 according to certain aspects. While FIG. 4 depicts operations of the RFID telemetry hub 210, it should be understood that the operations of the downhole RFID telemetry hub 210 may be performed by a single component or device, or across multiple different components or devices.

According to certain aspects, the RFID telemetry hub 210 receives data from multiple downhole tools. As shown, the RFID telemetry hub 210 may be communicatively coupled to multiple downlink equipment (downhole equipment 1, downhole equipment 2, . . . , downhole equipment M). The RFID telemetry hub 210 may have a wired and/or wireless (e.g., acoustic or other wireless connection) connection with the downlink equipment and perform data collection 402 over the connections with the downhole equipment. The downhole equipment may include well logging instruments, MWD instruments, LWD instruments, and/or other downhole equipment. In some aspects, the data from the different downhole tools is distinguished by a data type and/or a serial number of the downhole tool.

In some aspects, the RFID telemetry hub 210 performs time stamping 404 of the collected data. The RFID telemetry hub 210 may assign a time stamp to a set of data from the multiple downhole equipment.

In some aspects, the RFID telemetry hub 210 performs data compression 406 of the data. Compression of the data increases the efficiency of the data communication and thereby improved throughput. In some aspects, the RFID telemetry hub 210 compresses the data based on a payload size capability of the RFID tags of the RFID devices 302.

In some aspects, the RFID telemetry hub 210 perform data encryption 408 of the data.

In some aspects, the RFID telemetry hub 210 performs data buffering 410 of the data (e.g., of the time stamped, compressed, and/or encrypted data) until detection (e.g., notified by the RFID detector 208) of the RFID devices 302 and then starts broadcasting of the buffered data to the RFID devices 302. In some aspects, the RFID telemetry hub 210 buffers the data in a first-in-first-out (FIFO) buffer. As shown in FIG. 4, the RFID telemetry hub 210 may perform RFID device detection 412. In some aspects, the RFID telemetry hub 210 is notified by the RFID detector 208 that the RFID devices 302 are detected. The RFID telemetry hub 210 may then perform data RFID broadcasting 414 of the data to the RFID devices 302 (RFID device 1, RFID device 2, . . . . , RFID device N).

In some aspects, the RFID telemetry hub 210 further uses another type of telemetry, such as mud pulse telemetry, to send the data to the surface.

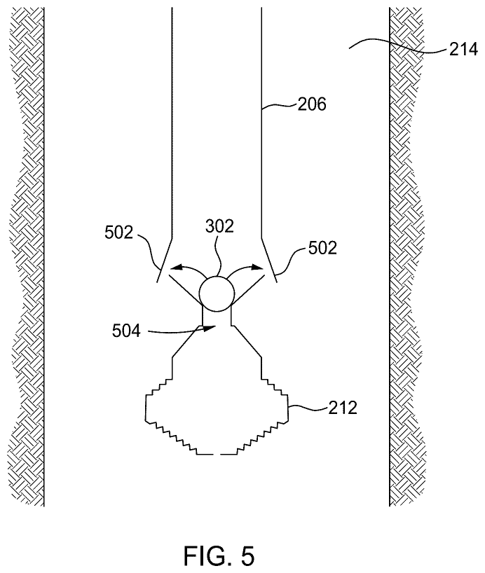

With reference again to FIG. 3, after passing the telemetry hub 210, the RFID devices 302 may pass from the inner drill string 206 to the annulus 214 to return to the surface. In some cases, the RFID devices 302 could be damaged (e.g., smashed) by the drill bit 212 as the RFID devices 302 pass through the nozzles to reach the annulus 214. According to certain aspects, the drilling system 200 may include a mechanism to eject the RFID devices 302 from the drill string 206 to the annulus 214 before the RFID devices 302 reach the drill bit 212. As shown in FIG. 5, a no-go section 504 of the mechanism near the drill bit 212 may have a diameter smaller in size than a diameter of the RFID devices 302 to prevent the RFID devices 302 from passing to the drill bit 212. In some aspects, the no-go section 504 is coupled to the drill bit 212. In some aspects, the no-go section 504 is coupled in the drill string 206 above (e.g., a few feet above) the drill bit 212. One or more flapper valves 502 may be located at or near the no-go section 504 of the drill string 206. The flapper valve(s) 502 are configured to open and close, to permit the RFID devices 302 to exit the drill string 206 into the annulus 214. In some aspects, as an RFID device 302 reaches the no-go section 504, the pressure applied from the surface to circulate the mud will push the RFID device 302 from the drilling string 206 tubing into annulus 214 through one of the flapper valve(s) 502. After opening to permit the RFID device 302 to exit the drill string 206, the flapper valve 502 is configured to shut.

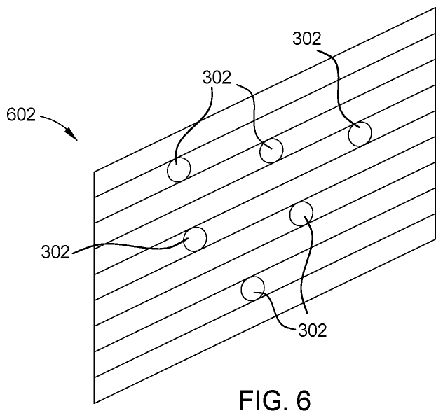

At the surface, the RFID devices 302 may be collected and read by another antenna (e.g., RFID reader) to harvest the data written to the RFID devices 302 by the telemetry hub 210. In some aspects, a segregator is used at the surface to collect the RFID devices 302. FIG. 6 illustrates a segregator 602 to collect the RFID devices 302 at the surface according to certain aspects. In some aspects, the segregator 602 collects the RFID devices 302 at the shaker 204 to collect the RFID devices 302 for cleaning. In some aspects, the segregator 602 collects the RFID devices 302 based on the outer diameter of the RFID devices 302. In some aspects, the RFID devices 302 are cleaned to remove the mud from the RFID devices 302 and then directed to a tray to pass in front of a RFID antenna at the surface to read the data.

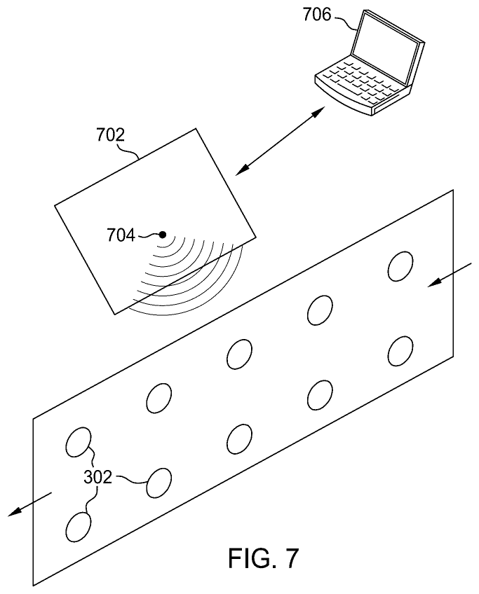

FIG. 7 illustrates reading of the RFID devices 302 at the surface and processing of the telemetry data. As shown, the RFID devices 302 may pass in front of an RFID receiver 702 at the surface. In some aspects, the RFID devices 302 are passed to the RFID receiver 702 after the segregating (e.g., as shown in FIG. 5) and cleaning the RFID devices 302. In some aspects, the RFID receiver 702 includes one or more RFID antennas 704 configured to read the telemetry data stored in the RFID tags embedded in the RFID devices 302. In some aspects, the RFID receiver 702 may be a mobile handheld RFID reader.

As shown, the RFID receiver 702 may send the telemetry data to one or more processing devices for further processing. While FIG. 7 depicts the telemetry data provided to a computer 706, it should be understood that the telemetry data may be sent to any processing device. In some aspects, the processing device may be integrated with the RFID receiver 702 or may be a separate component or device from the RFID receiver 702. The RFID receiver 702 may have a wired or wireless connection to the computer 706. In some aspects, the processing device is part of a downhole data acquisition system. In some aspects, the computer 706 may decrypt the encrypted data. In some aspects, the computer 706 may decompresses the compressed data. In some aspects, the computer 706 may process the raw data to generate one or more logs, reports, graphical displays, alerts, alarms, and/or to initiate one or more actions associated with the drilling operations of the well, such as for geosteering.

In some aspects, the surface equipment may provide an acknowledgement to the RFID telemetry hub 210 to inform the RFID telemetry hub 210 that the data was successfully received. Based on the acknowledgment, the RFID telemetry hub 210 may either retransmit the data (if an acknowledgment was not received for the data) or may stop broadcasting the data. In some aspects, the surface equipment may write the acknowledgment to the RFID devices 302 and resend the RFID devices 302 to the RFID telemetry hub 210. In some aspects, the surface equipment may send the acknowledgment to the RFID telemetry hub 210 using a different communication (e.g., electromagnetic, mud pulse, optic, or other).

In some aspects, the RFID telemetry methods, apparatuses, and systems described herein may provide a data communication bandwidth on the order of megabits per second.

In some aspects, the RFID telemetry methods, apparatuses, and systems described herein may allow automated downhole data harvesting.

In some aspects, the RFID telemetry methods, apparatuses, and systems described herein may be used optimize drilling operations.

In some aspects, the RFID telemetry methods, apparatuses, and systems described herein may increase the data rate and/or decrease the costs of communication between the surface and downhole equipment.

In some aspects, the RFID telemetry methods, apparatuses, and systems described herein may provide reliability to communications, such as provided by a backup, or additional, telemetry communications system in addition to another telemetry communication system to ensure the continuity of the data transmissions between the downhole and surface equipment in case of failure of one of the telemetry communication systems.

In some aspects, the RFID telemetry methods, apparatuses, and systems described herein may be used in any time of drilling system, including land based rigs, deep-water offshore rigs, jack-up rigs, or other type of drilling systems.

In some aspects, the RFID telemetry methods, apparatuses, and systems described herein may be used for other types of information, beyond data communication between downhole and surface equipment, such for the calculation of round-trip time in the well, which may be used to calculate lag time to project events or elements (e.g., gas or cuttings) received at the surface to depth.

### Example Method for RFID Telemetry

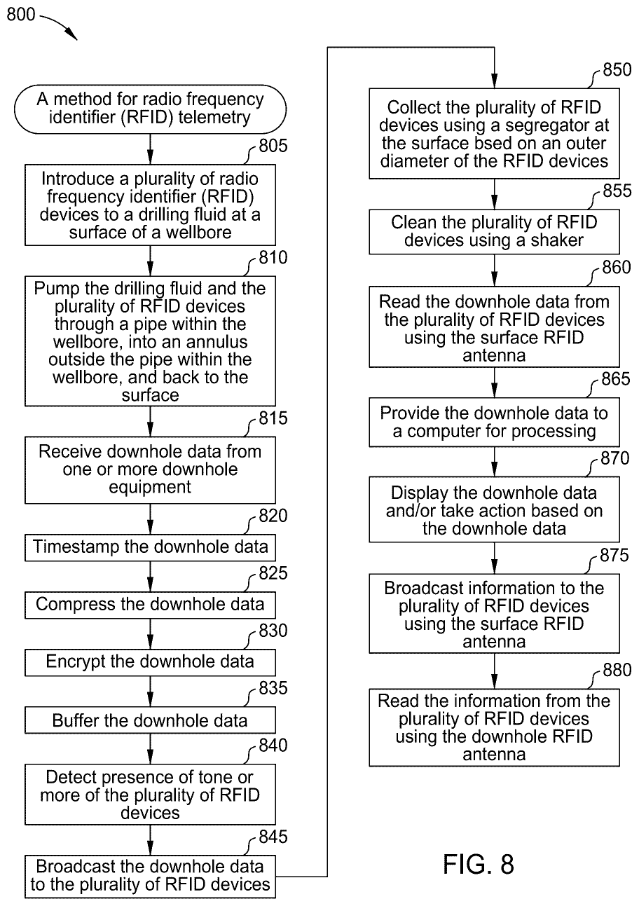

FIG. 8 illustrates an example workflow 800 for RFID telemetry communication between surface and downhole components at a wellbore. Aspects of the workflow 800 may be performed by a system for RFID telemetry.

As shown, the example workflow 800 may begin, at operation 805, with introducing a plurality of radio frequency identified (RFID) devices (e.g., RFID devices 302) to a drilling fluid at a surface of the wellbore. In some aspects, each of the plurality of RFID devices comprises one or more RFID tags within a spherical ball. In some aspects, the spherical ball is comprised of a material configured to withstand a temperature of up to 200 degrees Celsius. In some aspects, the spherical ball is composed of rubber.

The workflow 800 may include, at operation 810, pumping the drilling fluid and the plurality of RFID devices through a pipe (e.g., drill string 206) within the wellbore, into an annulus (e.g., annulus 214) outside the pipe within the wellbore, and back to the surface. In some aspects, the operation 810 includes pumping the plurality of RFID devices downhole from the surface of the wellbore to a downhole RFID antenna (e.g., RFID antenna 304).

The workflow 800 may include, at operation 845, broadcasting data to the plurality of RFID devices, using the downhole RFID antenna. In some aspects, the downhole RFID antenna is configured to transmit downhole data to the plurality RFID devices when the plurality of RFID devices reaches the downhole RFID antenna. In some aspects, the downhole data comprise well logging data.

In some aspects, the downhole RFID antenna is part of telemetry hub (e.g., telemetry hub 210). In some aspects, the telemetry hub includes memory storing computer executable code; and one or more processors configured to execute the computer executable code. In some aspects, the telemetry hub is communicatively coupled with a plurality of downhole equipment (e.g., downhole equipment 1, 2, . . . , M) and receives the downhole data (e.g., data collection 402) from the plurality of downhole equipment at operation 815.

In some aspects, the workflow 800 may include, at operation 820, time stamping the data (e.g., data timestamping 404) received from the plurality of downhole equipment.

In some aspects, the workflow 800 may include, at operation 825, compressing the data (e.g., data compression 406) received from the plurality of downhole equipment.

In some aspects, the workflow 800 may include, at operation 830, encrypting the data (e.g., data encryption 408) received from the plurality of downhole equipment.

In some aspects, the workflow 800 may include, at operation 835, buffering the time stamped, compressed, and/or encrypted data (e.g., data buffering 410). In some aspects, the buffering at operation 835 is in a FIFO buffer.

In some aspects, the workflow 800 may include, at operation 840, detecting a presence of the plurality of RFID devices (e.g., RFID device detection 412). The broadcasting at operation 845 may be in response to the detection (e.g., data RFID broadcasting 414). In some aspects, an RFID detector (e.g., RFID detector 208) located uphole of the telemetry hub, wherein the RFID detector is configured to detect a presence of the RFID devices and notify the telemetry hub of the detection of the presence of the RFID devices.

In some aspects, the broadcasting at operation 845 includes broadcasting, via the downhole RFID antenna, the same data to multiple of the RFID devices during a time period. In some aspects, the broadcasting at operation 845 stops broadcasting the data in response receiving an acknowledgment for the data.

The workflow 800 may include estimating a depth of one of the RFID devices as a function time, wherein the estimation comprises a backward volume calculation based on one or more properties of the drilling fluid, a rate of penetration, geometry of the wellbore, and a volume of the RFID device. In some aspects, the telemetry hub may determine a time to broadcast the data, via the downhole RFID antenna, to the RFID device based on the estimated depth of the RFID device.

In some aspects, a barrier (e.g., no-go section 504) is disposed in the drilling, downhole of the downhole RFID antenna and uphole of a drill bit (e.g., drill bit 212), wherein the barrier has an inner diameter that allows the drilling fluid to flow through the barrier but prevents the RFID devices from flowing through the barrier. One or more flapper valves (e.g., flapper valves 502) may allow the RFID devices to exit the drill string to the annulus.

In some aspects, the operation 810 includes pumping the plurality of RFID devices uphole back to the surface RFID antenna, wherein the plurality of RFID devices are configured to flow within an annulus outside the pipe in the wellbore.

In some aspects, the workflow 800 may include, at operation 850, collecting, using a segregator (e.g., segregator 602) located at the surface, the plurality of RFID devices based on an outer diameter of the RFID devices. In some aspects, the work flow 800 may include, at operation 855, providing the plurality of RFID devices to a shaker (e.g., shaker 204) and cleaning the plurality of RFID device before the RFID devices are passed to the surface RFID antenna.

The workflow 800 may include, at operation 860, reading the data using a surface RFID antenna at the surface (e.g., RFID antenna 704).

In some aspects, the workflow 800 may include, at operation 865, providing the downhole data to a computer (e.g., computer 706). In some aspects, the computer may be integrated with the surface RFID antenna. In some aspects, the providing the downhole data at operation 865 may via a wired or wireless network. In some aspects, the workflow 800 may include, at operation 870, processing the data, displaying the data, and/or taking an action based on the data (e.g., issuing an alert or alarm, making a drilling decision, geosteering, or other action).

In some aspects, the workflow 800 may include, at operation 875, broadcasting information, using the surface RFID antenna, to the plurality of RFID devices and, at operation 880, reading the information using the downhole RFID antenna.

According to certain aspects, a method performed by a telemetry hub for communication between surface and downhole components at a wellbore may include receiving, at one or more downhole processors, raw downhole data from a plurality of downhole well logging instruments. The telemetry hub may at least one of: time stamping, compressing, encrypting, or buffering the raw data. The telemetry hub may detect a presence of one or more radio frequency identified (RFID) devices flowing in a pipe within the wellbore. The telemetry hub may broadcast, using a downhole RFID antenna, the downhole data to the one or more RFID devices in response to the detection.

### Example Clauses

Implementation examples are described in the following numbered clauses:

Clause 1: A system comprising a first radio frequency identified (RFID) antenna at a surface of a wellbore; a second RFID antenna downhole in the wellbore; and a plurality of RFID devices configured to, while drilling fluid is being circulated inside the wellbore: flow downhole from a surface of the wellbore to the second RFID antenna, wherein the plurality of RFID devices are configured to flow within a pipe carrying the drilling fluid inside the wellbore; and flow uphole back to the first RFID antenna at the surface, wherein the plurality of RFID devices are configured to flow within an annulus outside the pipe in the wellbore, wherein the second RFID antenna is configured to transmit downhole data to the plurality RFID devices when the plurality of RFID devices reaches the second RFID antenna downhole; and wherein the first RFID antenna is configured to read the downhole data when the plurality of RFID devices reaches the first RFID antenna at the surface.

Clause 2: The system of Clause 1, wherein the plurality of RFID devices are further configured to: receive information from the first RFID antenna at the surface of the wellbore; and provide the information to the second RFID downhole in the wellbore.

Clause 3: The system of any combination of Clauses 1-2, wherein each of the plurality of RFID devices comprises one or more RFID tags within a spherical ball.

Clause 4: The system of Clause 3, wherein the spherical ball is comprised of a material configured to withstand a temperature of up to 200 degrees Celsius.

Clause 5: The system of any combination of Clauses 3-4, wherein the spherical ball is composed of rubber.

Clause 6: The system of any combination of Clauses 1-5, wherein the downhole data comprise well logging data.

Clause 7: The system of any combination of Clauses 1-6, further comprising a telemetry hub including the second RFID antenna, wherein the telemetry hub comprises: memory storing computer executable code; and one or more processors configured to execute the computer executable code, wherein the telemetry hub is communicatively coupled with a plurality of downhole equipment, and wherein the telemetry is configured to receive the downhole data from the plurality of downhole equipment.

Clause 8: The system of Clause 7, wherein the one or more processors are configured to: time stamp the data received from the plurality of downhole equipment; and provide the time stamped data to the plurality of RFID devices via the second RFID antenna.

Clause 9: The system of any combination of Clauses 7-8, wherein the one or more processors are configured to: compress the data received from the plurality of downhole equipment; and provide the compressed data to the plurality of RFID devices via the second RFID antenna.

Clause 10: The system of any combination of Clauses 7-9, wherein the one or more processors are configured to: encrypt the data received from the plurality of downhole equipment; and provide the encrypted data to the plurality of RFID devices via the second RFID antenna.

Clause 11: The system of any combination of Clauses 7-10, wherein the one or more processors are configured to: buffer the data received from the plurality of downhole equipment; and provide the data to the plurality of RFID devices via the second RFID antenna in response to detection of the RFID devices.

Clause 12: The system of Clause 11, further comprising an RFID detector located uphole of the telemetry hub, wherein the RFID detector is configured to: detect a presence of the RFID devices; and notify the telemetry hub of the detection of the presence of the RFID devices.

Clause 13: The system of any combination of Clauses 7-12, wherein the one or more processors are configured to broadcast, via the second RFID antenna, the same data to multiple of the RFID devices during a time period.

Clause 14: The system of Clause 13, wherein the one or more processors are configured to stop broadcasting the data in response receiving an acknowledgment for the data.

Clause 15: The system of any combination of Clauses 7-14, wherein the one or more processors are configured to: estimate depth of one of the RFID devices as a function time, wherein the estimation comprises a backward volume calculation based on one or more properties of the drilling fluid, a rate of penetration, geometry of the wellbore, and a volume of the RFID device; and determine a time to broadcast the data, via the second RFID antenna, to the RFID device based on the estimated depth of the RFID device.

Clause 16: The system any combination of Clauses 1-15, further comprising: a barrier disposed in the drill string, downhole of the second RFID antenna and uphole of a drill bit, wherein the barrier has an inner diameter that allows the drilling fluid to flow through the barrier but prevents the RFID devices from flowing through the barrier; and one or more flapper valves configured to allow the RFID devices to exit the drill string to the annulus.

Clause 17: The system of any combination of Clauses 1-16, further comprising a segregator located at the surface, wherein the segregator is configured to: collect the plurality of RFID devices based on an outer diameter of the RFID devices; and provide the plurality of RFID devices to a shaker for cleaning before the RFID devices are passed to the first RFID antenna.

Clause 18: A method for operating the system in accordance with any of Clauses 1-17.

Clause 19: A computer-readable medium comprising executable instructions that, when executed by one or more processors of an apparatus, cause the apparatus to operate the system in accordance with any of Clauses 1-17.

Clause 20: An apparatus comprising: a memory comprising executable instructions and one or more processors configured to execute the executable instructions and cause the apparatus to operate the system in accordance with any of Clauses 1-17.

Clause 21: An apparatus comprising means for operating the system in accordance with any of Clauses 1-17.

Clause 22: A method of communication between surface and downhole components at a wellbore, the method comprising: introducing a plurality of radio frequency identified (RFID) devices to a drilling fluid at a surface of the wellbore; pumping the drilling fluid and the plurality of RFID devices through a pipe within the wellbore, into an annulus outside the pipe within the wellbore, and back to the surface; broadcasting data to the plurality of RFID devices, using a downhole RFID antenna; and reading the data using a surface RFID antenna at the surface.

Clause 23: A computer-readable medium comprising executable instructions that, when executed by one or more processors of an apparatus, cause the apparatus to perform the method in accordance with Clause 22.

Clause 24: An apparatus comprising: a memory comprising executable instructions and one or more processors configured to execute the executable instructions and cause the apparatus to perform the method in accordance with Clause 22.

Clause 25: An apparatus comprising means for performing the method in accordance with Clause 22.

Clause 26: A method of communication between surface and downhole components at a wellbore, the method comprising: receiving, at one or more downhole processors, raw downhole data from a plurality of downhole well logging instruments; at least one of: time stamping, compressing, encrypting, or buffering the raw data; detecting a presence of one or more radio frequency identified (RFID) devices flowing in a pipe within the wellbore; and broadcasting, using a downhole RFID antenna, the downhole data to the one or more RFID devices in response to the detection.

Clause 27: A computer-readable medium comprising executable instructions that, when executed by one or more processors of an apparatus, cause the apparatus to perform the method in accordance with Clause 26.

Clause 28: An apparatus comprising: a memory comprising executable instructions and one or more processors configured to execute the executable instructions and cause the apparatus to perform the method in accordance with Clause 26.

Clause 29: An apparatus comprising means for performing the method in accordance with Clause 26.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of aspects discussed without departing from the scope of the disclosure. Various examples may omit, substitute, or add various procedures or aspects as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A system comprising:
a first radio frequency identified (RFID) antenna at a surface of a wellbore;
a second RFID antenna downhole in the wellbore; and
a plurality of RFID devices configured to, while drilling fluid is being circulated inside the wellbore:
flow downhole from the surface of the wellbore, through a central bore of a drill pipe in the wellbore, to the second RFID antenna, wherein the plurality of RFID devices are configured to flow within the drilling fluid inside the central bore of the drill pipe;
pass out of the central bore of the drill pipe into an annulus between the drill pipe and the wellbore; and
flow uphole, through the annulus between the drill pipe and the wellbore, back to the first RFID antenna at the surface, wherein the plurality of RFID devices are configured to flow within the drilling fluid in the annulus outside the drill pipe in the wellbore,
wherein the second RFID antenna is configured to transmit downhole data to the plurality RFID devices when the plurality of RFID devices reaches the second RFID antenna downhole; and
wherein the first RFID antenna is configured to read the downhole data when the plurality of RFID devices reaches the first RFID antenna at the surface.

2. The system of claim 1, wherein the plurality of RFID devices are further configured to:
receive information from the first RFID antenna at the surface of the wellbore; and
provide the information to the second RFID antenna downhole in the wellbore.

3. The system of claim 1, wherein each of the plurality of RFID devices comprises one or more RFID tags within a spherical ball.

4. The system of claim 3, wherein the spherical ball is comprised of a material configured to withstand a temperature of up to 200 degrees Celsius.

5. (canceled)

6. The system of claim 1, wherein the downhole data comprise well logging data.

7. The system of claim 1, further comprising a telemetry hub including the second RFID antenna, wherein the telemetry hub comprises:
memory storing computer executable code; and
one or more processors configured to execute the computer executable code,
wherein the telemetry hub is communicatively coupled with a plurality of downhole equipment, and
wherein the telemetry hub is configured to receive the downhole data from the plurality of downhole equipment.

8. The system of claim 7, wherein the one or more processors are configured to:
time stamp the downhole data received from the plurality of downhole equipment, resulting in time stamped data; and
provide the time stamped data to the plurality of RFID devices via the second RFID antenna.

9. The system of claim 7, wherein the one or more processors are configured to:
compress the downhole data received from the plurality of downhole equipment, resulting in compressed data; and
provide the compressed data to the plurality of RFID devices via the second RFID antenna.

10. The system of claim 7, wherein the one or more processors are configured to:
encrypt the downhole data received from the plurality of downhole equipment, resulting in encrypted data; and
provide the encrypted data to the plurality of RFID devices via the second RFID antenna.

11. The system of claim 7, wherein the one or more processors are configured to:
buffer the downhole data received from the plurality of downhole equipment, resulting in buffered data; and
provide the buffered data to the plurality of RFID devices via the second RFID antenna in response to detection of the plurality of RFID devices.

12. The system of claim 11, further comprising an RFID detector located uphole of the telemetry hub, wherein the RFID detector is configured to:
detect a presence of an RFID device of the plurality of RFID devices; and
notify the telemetry hub of the detection of the presence of the RFID device of the plurality of RFID devices.

13. The system of claim 7, wherein the one or more processors are configured to broadcast, via the second RFID antenna, the downhole data to multiple RFID devices of the plurality of RFID devices during a time period.

14. The system of claim 13, wherein the one or more processors are configured to stop broadcasting the downhole data in response receiving an acknowledgment for the downhole data.

15. The system of claim 7, wherein the one or more processors are configured to:
estimate depth of an RFID device of the plurality of RFID devices as a function of time, wherein estimating the depth comprises a backward volume calculation based on one or more properties of the drilling fluid, a rate of penetration, geometry of the wellbore, and a volume of the RFID device of the plurality of RFID devices; and
determine a time to broadcast the downhole data, via the second RFID antenna, to the RFID device of the plurality of RFID devices based on the depth of the RFID device of the plurality of RFID devices.

16. The system of claim 1, further comprising:
a barrier disposed in the drill pipe, downhole of the second RFID antenna and uphole of a drill bit connected to the drill pipe, wherein the barrier has an inner diameter that allows the drilling fluid to flow through the barrier but prevents the plurality of RFID devices from flowing through the barrier; and
one or more flapper valves configured to allow the plurality of RFID devices to exit the drill pipe to the annulus.

17. The system of claim 1, further comprising a segregator located at the surface, wherein the segregator is configured to:
collect the plurality of RFID devices based on an outer diameter of the plurality of RFID devices; and
provide the plurality of RFID devices to a shaker for cleaning before the plurality of RFID devices are passed to the first RFID antenna.

18. A method of communication between surface and downhole components at a wellbore, the method comprising:
introducing a plurality of radio frequency identified (RFID) devices to a drilling fluid at the surface of the wellbore;
pumping the drilling fluid and the plurality of RFID devices into a central bore of a drill pipe, through the central bore of the drill pipe within the wellbore, out of the central bore of the drill pipe into an annulus between the drill pipe and the wellbore, and back to the surface;
broadcasting data to the plurality of RFID devices, using a downhole RFID antenna; and
reading the data using a surface RFID antenna at the surface.

19. The method of claim 18, further comprising:
broadcasting information, using the surface RFID antenna, to the plurality of RFID devices; and
reading the information using the downhole RFID antenna.

20. A method of communication between surface and downhole components at a wellbore, the method comprising:
receiving, at one or more downhole processors, raw downhole data from a plurality of downhole well logging instruments;
at least one of: time stamping, compressing, encrypting, or buffering the raw data;
detecting a presence of one or more radio frequency identified (RFID) devices flowing in drilling fluid flowing through a central bore of a drill pipe within the wellbore; and
broadcasting, using a downhole RFID antenna, the downhole data to the one or more RFID devices in response to the detection prior to the one or more RFID devices flowing out of the central bore of the drill pipe and into an annulus between the drill pipe and the wellbore.

21. The system of claim 1, wherein the one or more flapper valves are configured to shut after opening to permit the plurality of RFID devices to flow out of the central bore of the drill pipe.
